(19) United States
(12) Patent Application Publication
(10) Pub. No.: US 2014/0053092 A1
(43) Pub. Date: Feb. 20, 2014

(54) Electronic control and display unit

(71) Applicant: CLAAS SELBSTFAHRENDE ERNTEMASCHINEN GMBH, HARSEWINKEL (DE)

(72) Inventors: Markus Grevinga, Saerbeck (DE); Michael Losch, Versmold (DE)

(73) Assignee: CLAAS SELBSTFAHRENDE ERNTEMASCHINEN GMBH, HARSEWINKEL (DE)

(21) Appl. No.: 13/962,206

(22) Filed: Aug. 8, 2013

(30) Foreign Application Priority Data
Aug. 17, 2012 (DE) 10 2012 107 550.6

(51) Int. Cl. G06F 3/0484; G06F 3/0486; G06F 3/0485

(52) U.S. Cl. CPC G06F 3/04842; G06F 3/0485; G06F 3/0486
USPC 715/769; 715/781; 715/784

(57) ABSTRACT

An electronic control and display unit includes a display and at least one control unit. The display has a set of visualization regions and can be operated in navigation levels. The display is subdivided into visualization regions within a navigation level and at least a portion of the visualization regions are movable relative to others of the visualization regions.

### CROSS-REFERENCE TO A RELATED APPLICATION

The invention described and claimed hereinbelow is also described in German Patent Application DE 10 2012 107550.6, filed on Aug. 17, 2012. The German Patent Application, subject matter of which is incorporated herein by reference, provides the basis for a claim of priority of invention under 35 U.S.C. 119(a)-(d).

### BACKGROUND OF THE INVENTION

The invention relates to an electronic control and display unit comprising a display and at least one control unit, wherein the display has a plurality of visualization regions at least a portion of which are movable relative to one another.

Display devices are known that enable users to visualize and edit processes, e.g. on mobile agricultural working machines; Document DE 102 03 370, for example, makes known a method for controlling a user interface to permit visualization of a plurality of control windows. In addition to the overlapping depiction of display windows (which is known per se), the aforementioned document proposes that, when an additional display window is activated, the currently activated display window is reduced in size such that the content of all active display windows is visible. Such systems have a primary disadvantage, however, that a plurality of information is visualized directly on the screen even if the information does not need to be monitored or edited at the time. This large amount of information can result in the overstimulation of an operator of the machine since a considerable amount of information is always accessible. As such, the operator must handle the priorization of this considerable amount of information by her or himself in order to distinguish important information from less important information. In addition, users find it difficult to orient themselves to such known display structured in this manner since the screen structure constantly changes.

Document EP 1 650 715 makes known a display procedure in which new information that is added and is needed for the particular process is visualized in an edge region of a display, while general machine-related information (previously the only information visualized on the monitor) is zoomed such that it is still readable. The new information, however, is positioned in an outer region of the display that is easily accessed and, therefore, easier to edit. Although a visualization device structured in such a way ensures better orientation on the screen, such systems also have the disadvantage that the large amount of visualized information may not be required for the process currently underway and can therefore result in unnecessary overstimulation of the driver operating the particular agricultural working machine.

### SUMMARY OF THE INVENTION

The present invention overcomes the shortcomings of known arts, such as those mentioned above.

To that end, the present invention provides a provides a visualization device that only visualizes context-relevant parameters, where the visualization presented is based on a repeating pattern to ensure rapid orientation of the operator.

In an embodiment, an electronic control and display unit comprises at least one display having a plurality of visualization regions and can be operated in navigation levels. The display is subdivided into visualization regions within a navigation level and at least a portion of the visualization regions can be moved relative to one another. Such inventive electronic control and display unit ensures that only context-relevant parameters are ever visualized and that visualization according to a repeating pattern results in the rapid orientation of the operator in the navigation levels. In an advantageous embodiment of the invention, the movability of the visualization regions relative to one another includes horizontal and/or vertical scrolling of the particular visualization region, and so the operator is confronted here with an efficient, widespread navigation structure that is easy to learn and quickly leads to the parameter to be selected on the display.

The display comprises, in a first navigation level, at least one “working phase” visualization region and one “tool menu” visualization region, wherein the “working phase” visualization region is scrollable horizontally and the “tool menu” visualization region is scrollable vertically. As such, the operator can quickly discern which tools are available and which working environments that relate to the available tools are themselves available.

In order to provide the operator with an instant overview of the working phases that are available and can be selected in a first menu level, the invention provides that a display field becomes visible during scrolling of the “working phase” visualization region that displays all the selectable working phases and that the particular working phase (that is activated) is visualized in an emphasized manner.

In order to ensure that the inventive control and display unit can be used universally on highly diverse agricultural working machines and, in highly diverse working stages, the invention provides that the “working phase” visualization region comprises the working phases “preparation”, “road travel”, “field travel”, and “headland” and that the visualization region of each working phase comprises a “working phase content” display region and at least one “tool view” display region.

In order to ensure that the only information ever visualized on the display is the information relevant to the current application, at least the contents of the “working phase content” and “tool view” visualization regions are coupled to one another such that selecting specific content in the “working phase content” visualization region results in the automatic adaptation of the content of the “tool view” visualization region and, vice versa, that selecting specific content in the “tool view” visualization region results in an automatic adaptation of the content of the “working phase content” visualization region.

In order to ensure that the operator permanently and subconsciously knows which navigation level is currently being navigated, the display structure is designed such that a second navigation level has at least one “tool content” visualization region, one “tool menu” visualization region and one “tool submenu” visualization region and that all visualization regions are scrollable vertically. Given that scrolling can only be performed vertically in this navigation level, the user immediately recognizes which menu level is currently being navigated based on the type of operation.

Efficient operation of the control and display unit is ensured when the display is designed as a touchscreen monitor and the visualization regions in the particular navigation level are moved by touching the touchscreen monitor. Even greater flexibility of operation is achieved in this context when control elements are assigned to the display, thereby also permitting the display to be navigated by actuating the buttons or a combination of both.

In order to ensure that the operator quickly reaches the desired important information or parameter settings, even without navigating the display, the invention provides that a display region visualized in all navigation levels is assigned to the display and comprises at least one “favorites” display region and a “hotkey” display region. System-relevant information is permanently visualized in the “favorites” display region and navigation level-relevant information is visualized in the “hotkey” display region by activating this display region. Since it is often necessary to change a plurality of important machine parameters, activation of the “hotkey” display region opens a “content” pop-up window that at least partially overlaps the “working phase” visualization region and wherein the content of the “content” pop-up window is visualized and then edited by vertical scrolling or actuating control elements.

In order to quickly move from one working phase to another, a header menu bar (which is visualized in all navigation levels), is assigned to the display and wherein activation of the header menu bar results in the immediate activation of the “working phases” visualization region.

In order to ensure that only relevant parameters are ever visualized within a navigation level as well, the visualization regions of each navigation level of the display are coupled to one another such that editing one visualization region results in the automatic adaptation of the content of the corresponding visualization region(s).

Preferably, a selected tool can be quickly deselected or cancelled in that touching an activated visualization region outside of an icon that describes the visualization region causes an activated menu window to close, and/or causes implemented changes to be reset.

To ensure that the operator can optimally adapt the display structure to his needs, the invention provides that the configuration of the display is editable in at least one of the available navigation levels. In the simplest case, this free configurability can be ensured in that, in the first navigation level, the “working phase content” and “tool view” visualization regions comprise a plurality of configurable subregions and each of the subregions is editable such that the content of a tool stored in the “tool menu” visualization region is draggable into the particular subregion.

Good transparency in working through adjustment options on the display is achieved when the selected tool has a plurality of editing options. These options are selected by opening a “content” pop-up window that at least partially overlaps the display and selecting the editing options therein. In order to ensure that the operator remains informed as to which navigation level is being navigated even while navigating an open “content” pop-up window, the “content” pop-up window is opened and closed by moving the “content” pop-up window horizontally into and out of the display, while vertical scrolling is used to navigate between selectable editing options.

A rapid switch from one navigation level to the other is ensured in that, after a working phase has been activated in the “working phase” visualization region, a plurality of icons that describe the working phase is displayed, and navigation within this working phase and/or switching from the first navigation level to the second navigation level is achieved at least by activating an icon. In order to ensure that the information as to which menu level is currently being navigated remains even after an icon is activated, the invention provides that activating an icon opens a “content” pop-up window, which at least partially overlaps the display. The content of this “content” pop-up window is visualized and then edited at least by vertical scrolling.

In order to ensure that the operations to be performed in the display remain recognizable to the operator even in this context, the “content” pop-up window, which overlaps at least partially, is visualized by being moved horizontally into the visualization region of the display.

Depending on the complexity of a selected tool, it may be necessary to edit parameters in several levels, wherein general settings as well as highly specific parameter settings can play a role. In the invention, the inserted “content” pop-up window comprises one or more icons and activating one of the icons positions at least one further “content” pop-up window over the “content” pop-up window that is already visualized, wherein the content of the “content” pop-up window opened most recently can be visualized and then edited at least by vertical scrolling.

In order to ensure that only that information is ever visualized in the display that is required for the particular adjustment procedure even when lower-order “content” pop-up windows are opened, the invention provides that a plurality of further “content” pop-up windows can be activated. Each of the subsequently activated “content” pop-up windows is positioned over the previously activated “content” pop-up window by being dragged horizontally into the visualization region of the display.

A particularly suitable parameter set-up that is easily implemented and understood by the operator is ensured when the activated icon represents a parameter of a working machine and activating the icon results in at least one virtual rotary switch being shown on the display, wherein the virtual rotary switch can be edited in order to change the parameter of the working machine. In this context, user-friendliness is further increased in that the virtual rotary switch is editable by dragging a marker in a linear or circular motion and the mark is activated via the touchscreen function or via control elements assigned to the display, preferably rotate-and-press switches.

The inventive control and display unit can be used in a highly flexible and efficient manner to optimize application conditions of an agricultural working machine when the parameters that can be edited using the control and display unit are machine parameters, quality parameters of the agricultural working machine, quality parameters of the crop and crop parameters.

Given that the “tool menu” visualization region comprises all the tools that are available on the agricultural working machine, the inventive control and display unit ensures that the agricultural working machine can be operated using a single control and display device.

In an embodiment, the control and display unit includes a “control and set-up instructions” tool to ensure that the operator is provided with efficient means for quickly carrying out necessary tasks on the machine himself.

In order to increase the recognizability of certain information on the display and to eliminate the need to remove any of the necessary information from the display region, the invention provides that the display is designed as a touchscreen monitor and that the touchscreen monitor can be zoomed in regions.

Since agricultural working machines often have different adjustment functions associated with the right- and left-side regions thereof, the operator of the agricultural working machine may also need a mirror-image view of the machine. In order to ensure that the display structure can be easily adapted accordingly, the invention provides that the display is designed as a touchscreen monitor and comprises a plurality of visualized icons. Touching the touchscreen monitor with two fingers making a rotational motion prompts the particular icon to be displayed as a mirror image while the original depiction of the icon is retained.

In order to permit rapid navigation within open selection windows, the inventive display is a touchscreen monitor and wherein scrolling the particular visualization region horizontally or vertically using two fingers increases the scrolling speed.

### BRIEF DESCRIPTION OF THE DRAWINGS

Further features and advantages of the invention will become apparent from the description of embodiments that follows, with reference to the attached figures, wherein:

FIG. 1 depicts a combine harvester with a control and display unit according to the invention;

FIG. 2A depicts the inventive control and display unit in a first navigation level;

FIG. 2B depicts the control and display unit in a second navigation level;

FIG. 3 depicts navigation using the inventive control and display unit in a first navigation level;

FIGS. 4A-D together depict how the display structure is changed in one navigation level according to the inventive control and display unit;

FIG. 5A-5E together depict a sequence highlighting how parameters are changed in one navigation level, according to the invention;

FIGS. 6A-6F together depict the navigation in a further navigation level according to the invention;

FIG. 7 depicts activation of a hotkey function and navigation therein according to the invention;

FIGS. 8A-8D together depict functions for activating a touchscreen monitor according to the invention; and

FIGS. 9A, 9B together depict navigation in a “control and set-up instructions” tool, according to the invention.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

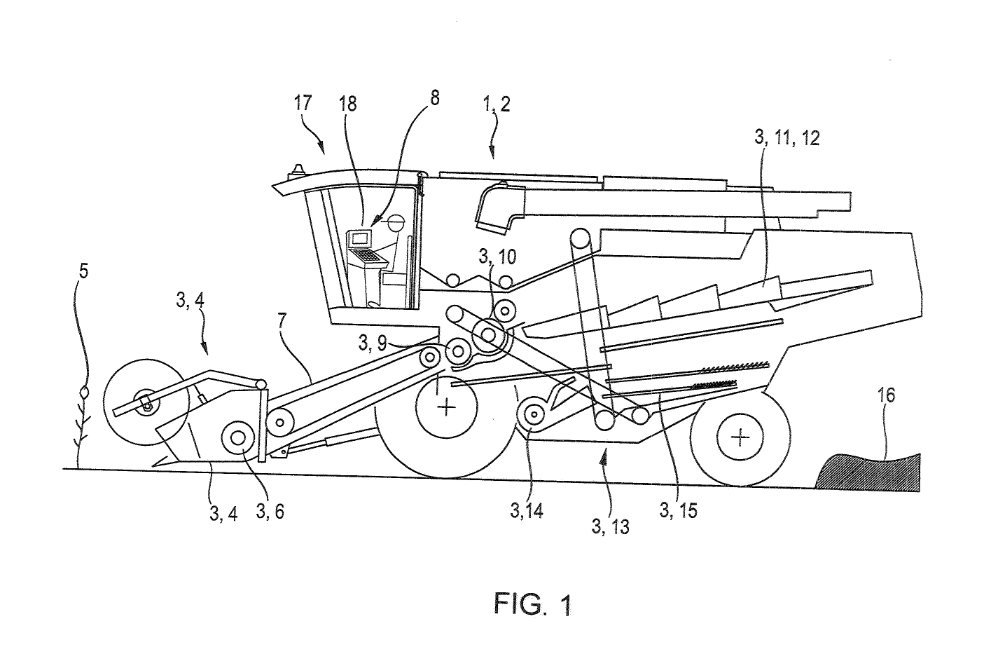

FIG. 1 shows an agricultural working machine 1 configured as a combine harvester 2 and the working units 3 thereof. The combine harvester 2 accommodates a header 4 in the front region thereof, wherein the header 4 picks up crop 5, cuts the crop and transfers the crop via a feed device 6 to the downstream feed rake 7. Via the feed rake 7, the crop 5 is transferred in a manner known per se to the threshing devices. In this case, the threshing devices comprise a first cylinder 9 and, downstream thereof, a second cylinder 10. To further separate the grain, the crop stream is conveyed to a separating device 11, such as a tray-type shaker 12 and to a cleaning device 13. The cleaning device 13 comprises a fan 14 and cleaning sieves 15. After passing through the cleaning device, the straw is ejected from the rear region of the combine harvester 2 and is deposited in a swath 16 on the ground or is widely distributed on the ground, for example. Using the inventive electronic control and display unit 8 (which is disposed in the cab 17), the driver of the combine harvester 2 can enter the settings for the various working units 3 and thereby adapt the harvesting operation to the specific crop conditions. In addition, the driver of the combine harvester 2 always has an overview of the machine and/or crop data visualized in the display 18 of the control and display unit 8 disposed in the cab 17. While the agricultural working machine 1 depicted in FIG. 1 is a combine harvester 2, the invention is not limited to use therein but also may be incorporated in a forage harvester, a tractor of like agricultural working machine.

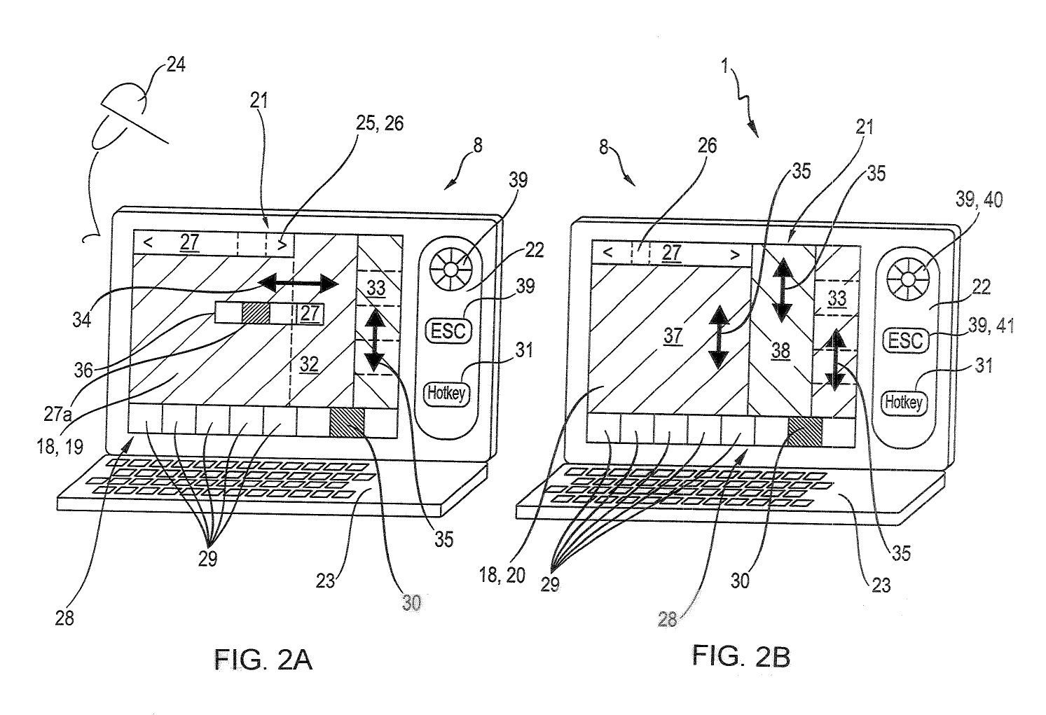

FIGS. 2A and 2B depict the inventive control and display unit 8. FIG. 2A depicts a first navigation level 19 and FIG. 2B depicts a second navigation level 20 of the display 18 of the control and display unit 8. In addition to the display 18, which is a touchscreen monitor 21, the control and display unit 8 comprises a first control unit 22 and at least one further control unit 23. The first control unit 22 permits navigation within one navigation level 19, 20 and the at least one further control unit 23 enables input by operator 24. It lies within the scope of the invention for the first and second control units 22, 23 to be combined to form a single control unit in a non-illustrated manner.

The display 18, which is a touchscreen monitor 21, has a display region 26 at the top thereof designed as a header menu bar 25 and is displayed permanently at least in the first navigation level 19. The header menu bar 25 comprises the working phases 27 of the agricultural working machine 1, wherein each of the working phases 27 can be selected in that the operator 24 of the agricultural working machine 1 horizontally scrolls the header menu bar 25 via touchscreen functionality.

A further display region 28 is provided at the lower edge of display 18 in a way that is visible at all navigation levels 19, 20. The display region 28 comprises a “favorites” 29 display region and a “hotkey” 30 display region. System-relevant information is permanently visualized in the “favorites” 29 display region and navigation level-relevant information is visualized in the “hotkey” 30 display region by activating the particular display region 29. The navigation level-relevant information stored in the “hotkey” button 30 is activated either by touching this button on the display 18 (which is designed as a touchscreen monitor 21), or by pressing the “hotkey” button 31 disposed in the first control unit 22.

The display 18 can be operated at navigation levels. The display 18 comprises, in a first navigation level 19, at least one “working phase” visualization region 32 and a “tool menu” visualization region 33, wherein the operator 24 of the agricultural working machine 1 can navigate in the particular visualization region 32, 33 by horizontally scrolling 34 in the “working phase” navigation region 32 and vertically scrolling 35 in the “tool menu” visualization region 33. Since the display 18 is designed as a touchscreen monitor 21, the horizontal and vertical scrolling 34, 35 is accomplished by touching the display 18 and dragging the particular visualization region 32, 33 in the desired direction.

To ensure that the operator 24 is informed about which working phase 32 is currently activated while scrolling in the “working phase” visualization region 32, a further display field 36 appears in the display 18. The further display field shows all the selectable working phases 27, wherein the currently activated working phase 27a is visualized in an emphasized manner.

In the further navigation level 20, the display 18 comprises at least one “tool content” visualization region 37, the “tool menu” visualization region 33 and a “tool submenu” visualization region 38. Each of these visualization regions 33, 37, 38 is navigated by vertical scrolling 35. In a manner analogous to the first navigation level 19, the vertical scrolling 35 is carried out by touching the display 18 and dragging the particular visualization region 33, 37, 38 in the desired direction. Moreover, in the second navigation level 20, navigation between the visualization regions 33, 37, 38 and within each visualization region 33, 37, 38 is carried out by control elements 39 assigned to the first control unit 22.

In the exemplary embodiment shown, the first control unit 22 comprises a control element 39 designed as a rotate-and-press switch 40. The rotate-and-press switch 40 is rotated in order to switch back and forth between the visualization regions 33, 37, 38 and to navigate within a visualization region 33, 37, 38. The rotate-and-press switch 40 is pressed in order to confirm or select a selected function. The further control element 39 comprises an escape button 41 and is used to reset an edit implemented using the rotate-and-press switch 40.

Given that the display 18 can be operated in the above-described first and second navigation levels 19, 20, wherein the display 18 is subdivided in a navigation level 19, 20 into visualization regions 32, 33, 37, 38 and at least one portion of the visualization regions 32, 33, 37, 38 can be moved relative to one another, a navigation style is created that enables the operator 24 of the agricultural working machine 1 to change machine parameters quickly and transparently. The orientation within the available navigation levels 19, 20 also is further increased in that only horizontal scrolling 34 is implemented in a first navigation level 19, while only vertical scrolling 35 is implemented in the at least one further navigation level 20. The main effect thereof is that the operator 24 of the agricultural working machine recognizes which navigation level 19, 20 is currently being navigated on the basis of the movement of the visualization regions 32, 33, 37, 38.

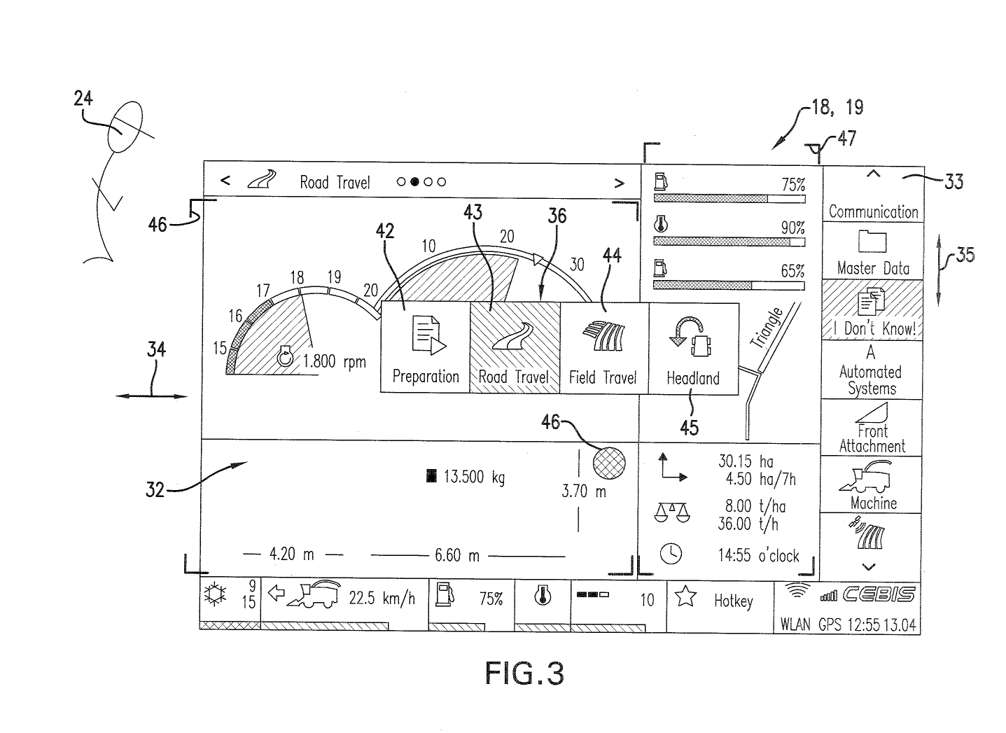

FIG. 3 provides a detailed view of the display 18 at the first navigation level 19. The display field 36 visualizes the available working phases and comprises the working phases “preparation” 42, “road travel” 43, “field travel” 44 and “headland” 45. The visualization region of each working phase 42-45 is structured such that the visualization region comprises a “working phase content” visualization region 46 and at least one “tool view” visualization region 47. In the first navigation level 19, the operator 24 can select the desired working phase 42-45 by touching 48 the display 18 with a finger or a suitable object. The operator either scrolls the “working phase” visualization region 32 in the horizontal direction 34 or taps the desired working phases 42-45 directly in the additional display field 36. Independently thereof, the operator 24 can navigate in the first navigation level 19 by vertical scrolling 35 in the “tool menu” visualization region 33 in a manner to be described in greater detail.

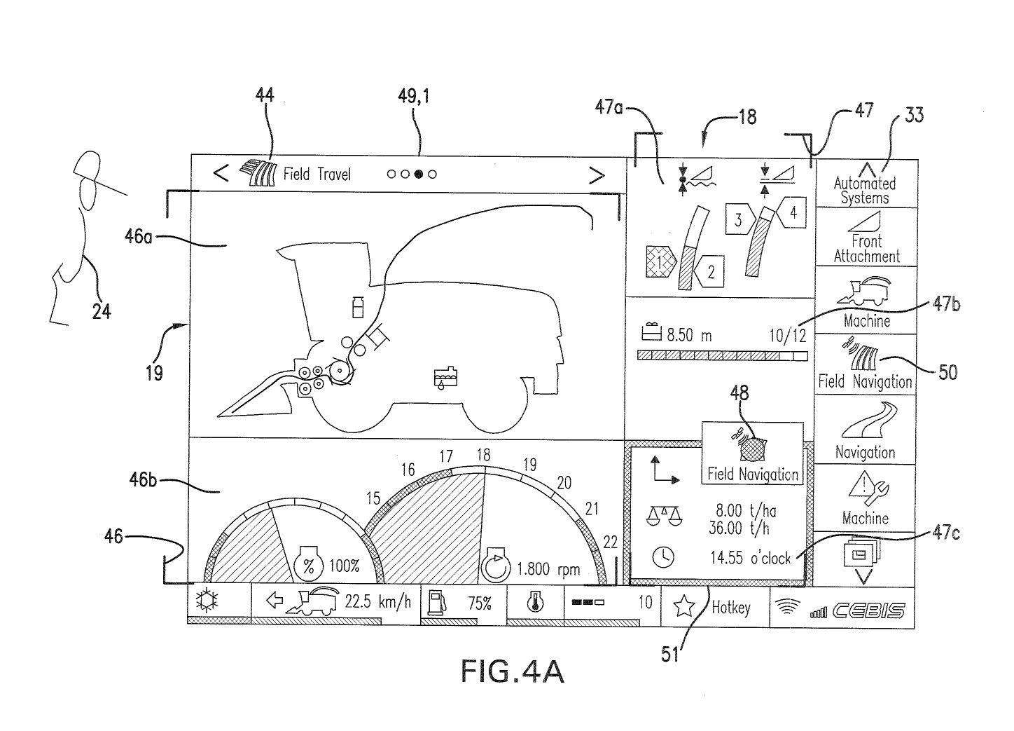

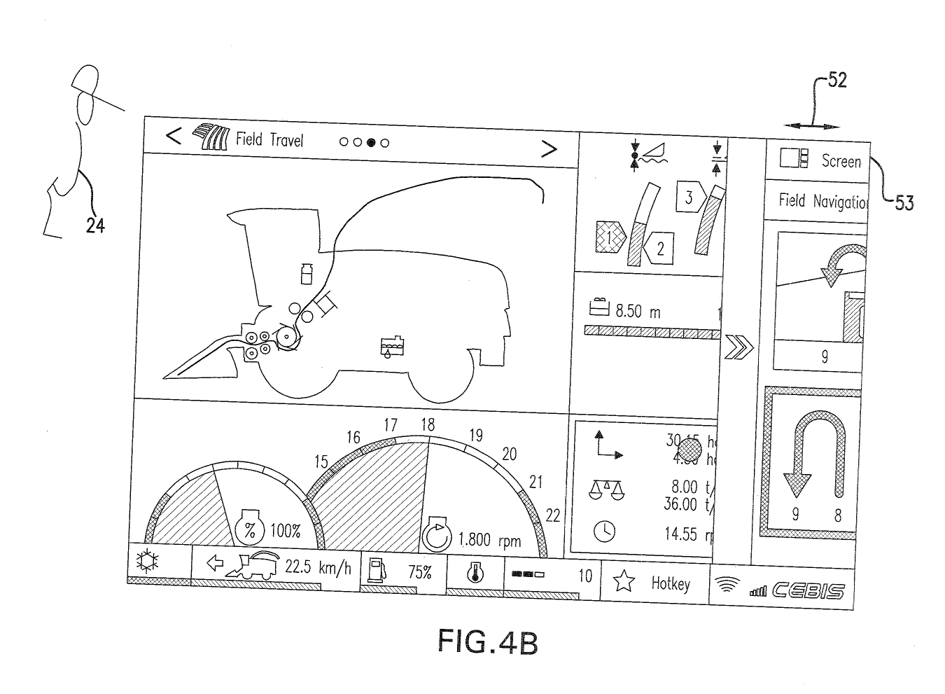

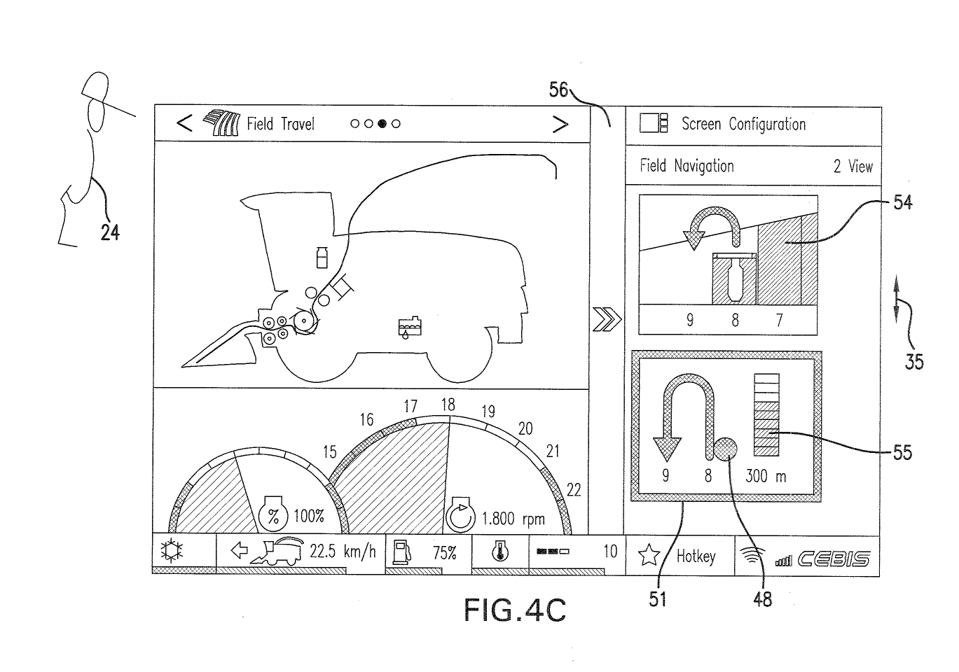

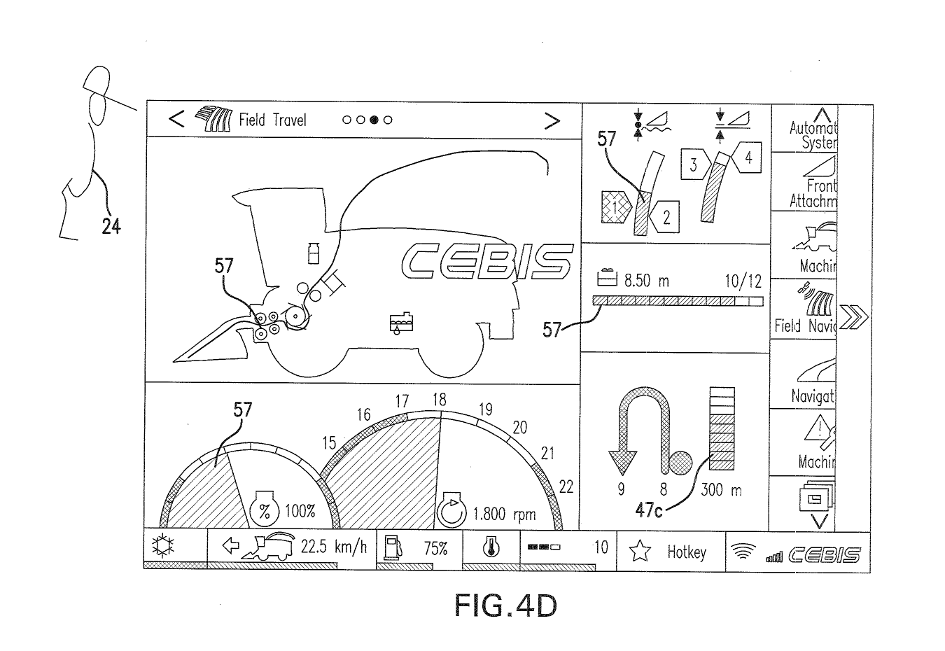

FIGS. 4A, 4B, 4C, 4D relate to an agricultural working machine 1 designed as a self-propelled forage harvester 49 and together show how the structure of the display 18 is changed in the first navigation level 19. Although the change in the display structure is described in the following by reference to the first navigation level 19, such procedure also applies to change the display structure in the second navigation level 20, where a description of this procedure is omitted for simplicity.

As shown, the operator 24 of the forage harvester 49 selected the “field travel” working phase 44. The “working phase content” 48 and “tool view” 47 visualization regions are both subdivided into subregions 46a-b, 47a-c, wherein the bits of information visualized in the subregions 46a-b, 47a-c can be replaced within subregions. To perform editing, the operator 24 first selects a tool 50 (the “field navigation” tool in this case) via touch 48 in the “tool menu” visualization region 33 and, drags the selected tool to one of the subregions 46a-b, 47a-c of the “working phase content” 46 or “tool view” 47 visualization regions.

As shown, the “field navigation” tool 50 is dragged to the lowermost subregion 47c of the “tool view” visualization region 47, wherein activation of the subregion 47c is indicated by a border 51 that is emphasized using color. If the operator 24 interrupts the contact in this subregion 47c, a “content” pop-up window 53, which moved into the display from right to left in the horizontal direction 52, opens. The “content” pop-up window comprises two alternative editing options 54, 55 for the “field navigation” tool 50. When the operator 24 selects, via touch 48, one of the alternative editing options 54, 55 in the “content” pop-up window 53 (which completely covers the “tool view” visualization region 47), this editing option 55 is initially visually emphasized to indicate the selection thereof. In the simplest case, the border 51 is emphasized using color. If the operator 24 then activates a closing bar 56 positioned in the “content” pop-up window 53, the “content” pop-up window 53 is closed by being moved horizontally 52 out of the display 18. Simultaneously, the selected editing option 55 has filled the previously selected, lowermost subregion 47c of the “tool view” visualization region 47. It lies within the scope of the invention for the selectable editing options 54, 55 to not be limited to visual aspects, but rather to also have various functions. It is also possible for more than the two described editing options 54, 55 to be available, in which case navigation between the selectable editing options 54, 55 is carried out by vertical scrolling 35 in the open “content” pop-up window 53.

To switch from the first navigation level 19 to the next navigation level 20 after a desired working phase is selected, the operator 24 touches one of the “working phase content” 46 or “tool view” 47 visualization regions. If the touch 48 takes place in the region of one of the icons 57 visualized on the display 18, the function or application associated with the icon 57 that is touched opens immediately. In more detail, if a region between the icons 57 is touched, the only result is the switch between the navigation levels 19, 20, without this directly changing the display structure.

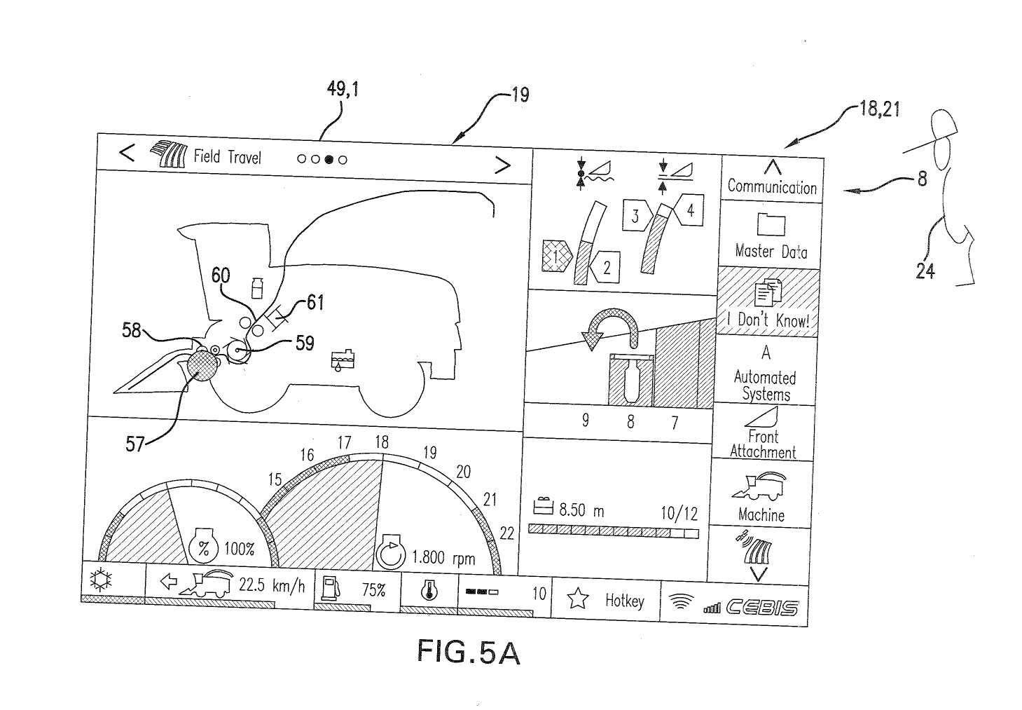

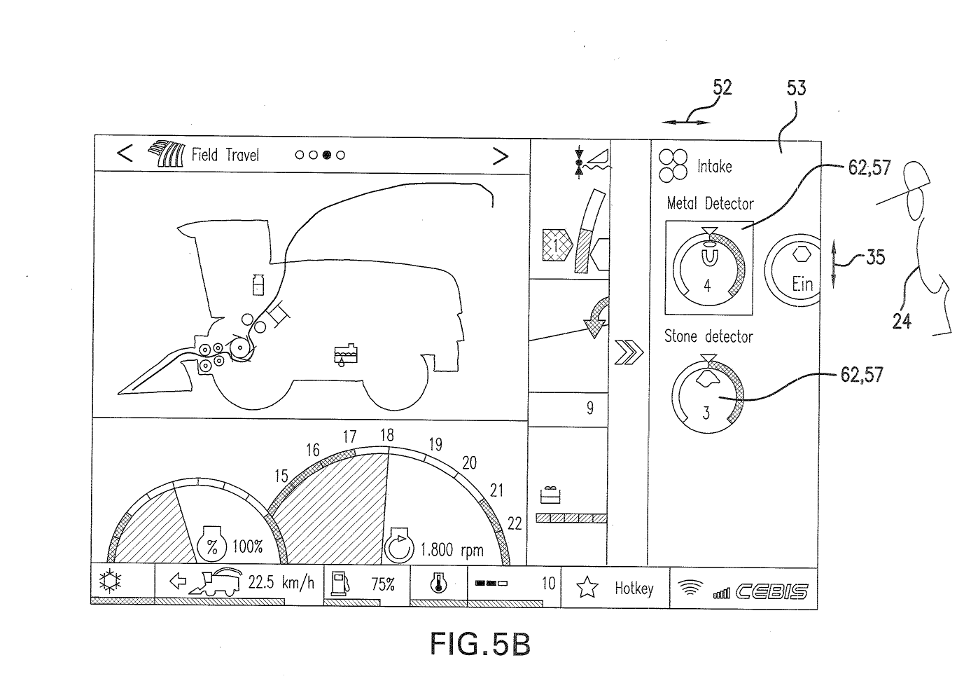

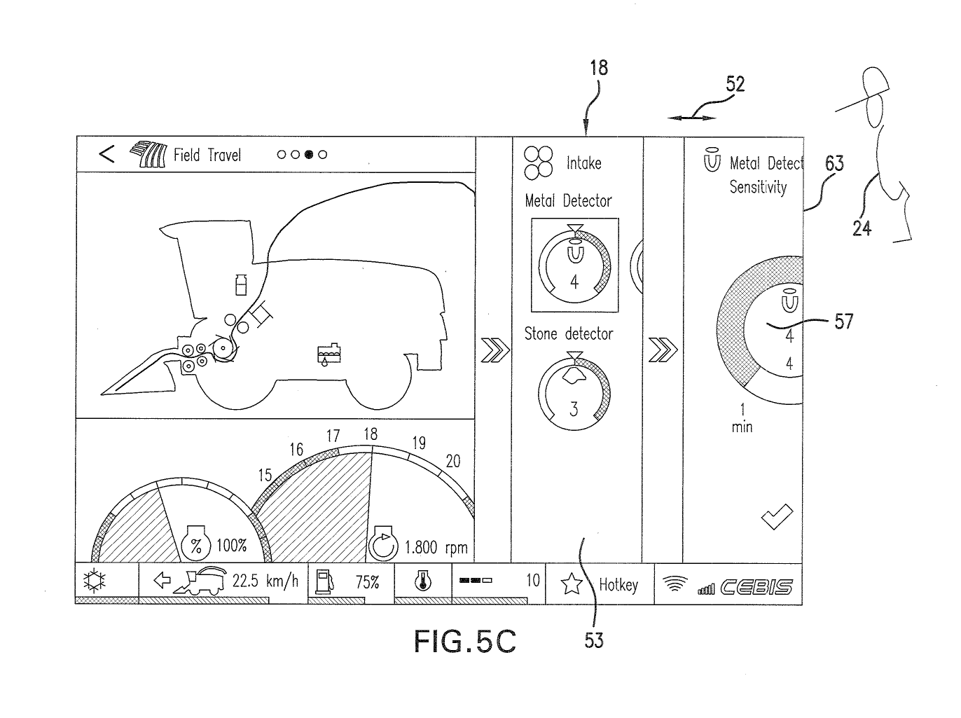

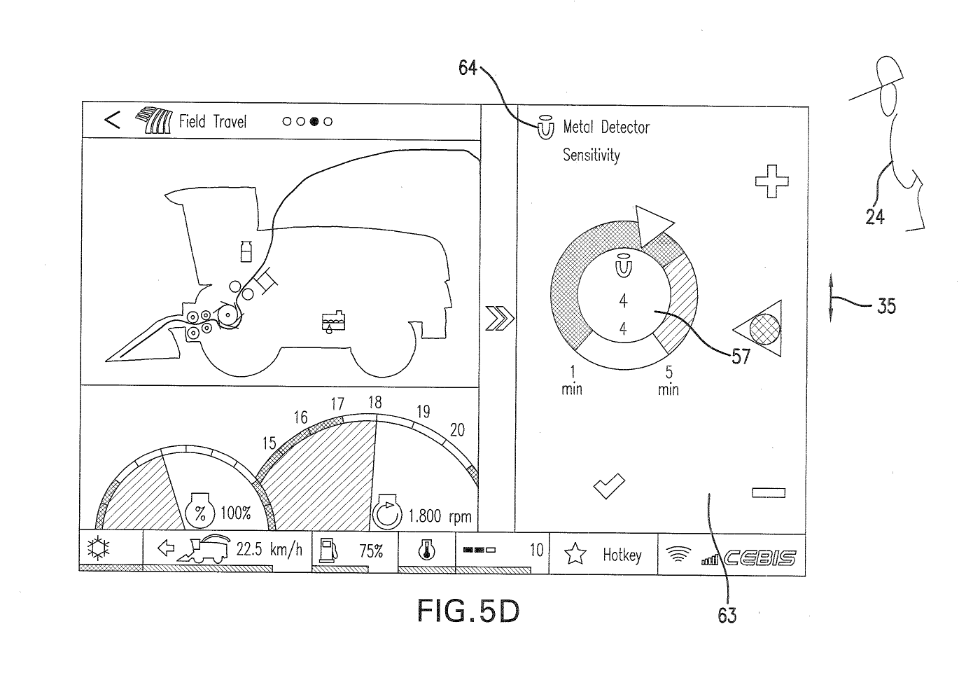

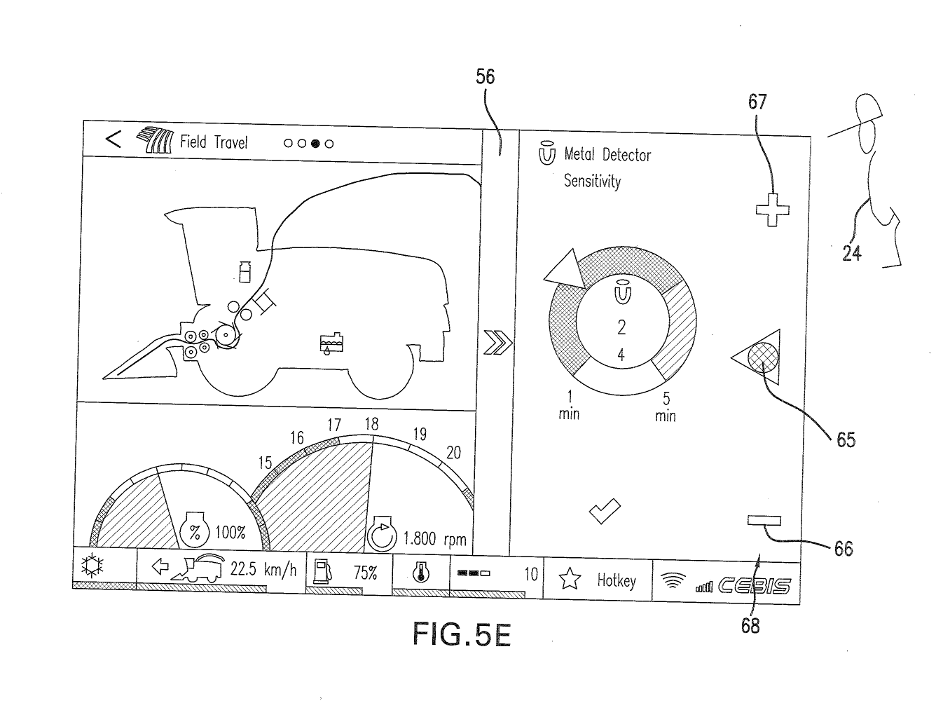

FIGS. 5A, 5B, 5C, 5D, 5E together describe a further variant of navigation in the first menu level 19 in an example wherein it is assumed that the agricultural working machine 1 is designed as a forage harvester 49. A forage harvester 49 comprises intake conveyor mechanisms 58, a chopping assembly 59, a post-fragmentation device 60 disposed downstream thereof and a post-accelerator 61 for conveying the chopped crop out of the forage harvester 49. In order to describe this variant of navigation in the first menu level 19, reference will be made to the sensitivity setting of a so-called metal detector in the region of the intake conveyor mechanisms 58 of the forage harvester 49.

First, the operator 24 touches the display 18 (which is a touchscreen monitor 21), in the region of the icon 57 that represents the intake conveyor mechanisms 58. The touch activates another “content” pop-up window 53, which contains different content, such that the “content” pop-up window 53 moves into the display 18 once more in the horizontal direction 52. The “content” pop-up window 53 at least partially overlaps the available display surface of the display 18. In analogy to the previously described changing of the display structure, a plurality of editing options 61, such as the editing of a metal detector and the editing of a stone detector in this case, are available in the “content” pop-up window 53.

The operator 24 then selects the desired editing option 62 (namely changing parameters of the metal detector in this case), by touching the icon 57 representing the editing option 62; the selected icon 57 changes color to indicate selection thereof. Another “content” pop-up window 63 then opens automatically so that it is moved into the display 18 in the horizontal direction 52 and, in the editable position thereof, completely covers the previously open “content” pop-up window 53. The “content” pop-up window 63 (which is now open), comprises a plurality of icons 57 by which parameters 64 of the agricultural working machine 1 (designed as a forage harvester 49) are edited (namely the sensitivity of the metal detector in this case).

In addition to an embodiment configured with the two above-described “content” pop-up windows 53, 63, the invention may alternatively provide that a plurality of “content” pop-up windows can be positioned one over the other, wherein the number of “content” pop-up windows depends on the editing function to be depicted. The particular “content” pop-up window 53, 63 is closed by activating a closing bar 56 associated with the particular “content” pop-up window 53, 63 or by activating the previously described escape button 41.

The editable parameter 64 can be changed by actuating a marker 65 directly on the display 18 (designed as a touchscreen monitor 21). Various change modes are disclosed in the exemplary embodiment shown. A first change mode is that of making a change using a virtual sliding switch 66 in which a marker 65 is moved linearly in the vertical direction. However, the position of the marker 65 also can be changed by touching the + and − symbols 67, 68 directly on the touchscreen monitor 21. The parameter 64 also can be changed by use of a virtual rotary switch 69 in such a way that the position of the marker 65 is changed by touching the touchscreen monitors 21 with a circular motion. Preferably, all the change modes are integrated in the display 18, thereby permitting the parameter 64 to be changed by use of the linearly displaceable marker 65 of the virtual sliding switch 66, while the marker 65 of the virtual rotary switch 69 directly displays the actual value of the changed parameter 64. It also is possible for only one change mode to be available on the display 18. In such case, the virtual sliding switch 66 must indicate the change not only in a qualitative manner, e.g. + means higher and − means lower, but also in a quantitative manner.

In addition, each of the “content” pop-up windows 53, 63 can be designed such that the available editing options 62 and parameters 64 can be navigated by vertical scrolling 35 within the particular “content” pop-up window 53, 63 where it is not possible to display all available editing options 62 and parameters 64 in a single display region in a meaningful manner. For that matter, if the control and display unit 8 does not comprise a display 18 designed as a touchscreen monitor 21, the marker 65 also can be moved by control elements 39 described by reference to FIG. 2, in the manner disclosed therein.

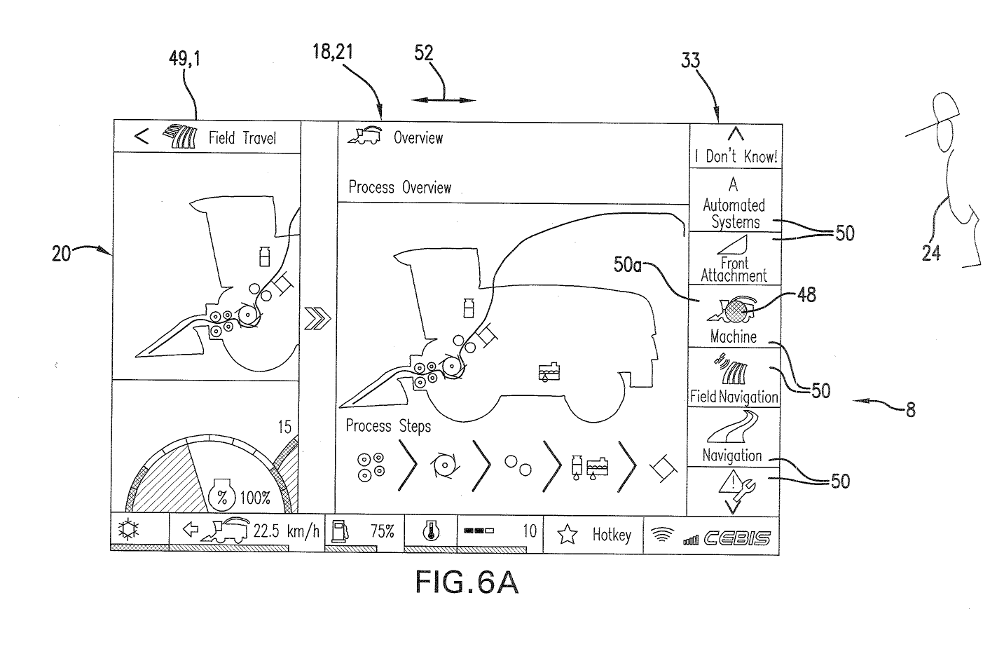

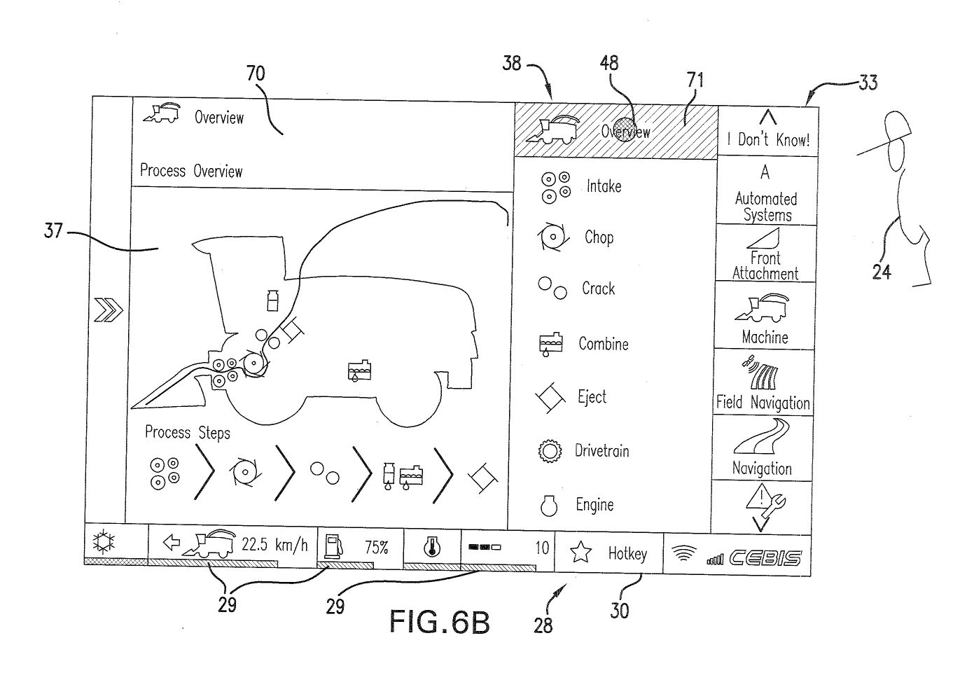

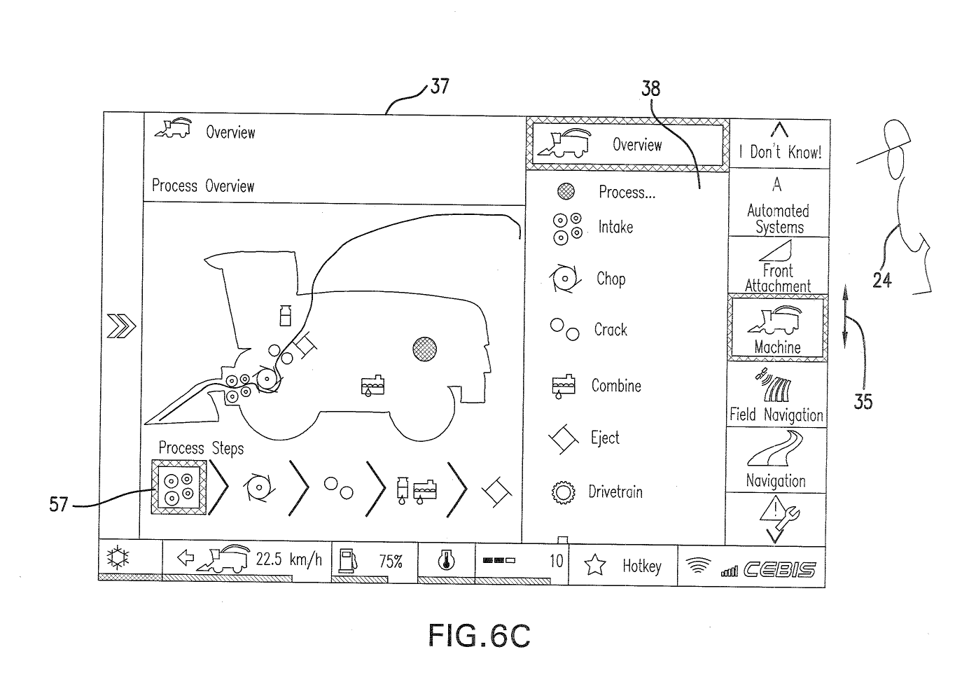

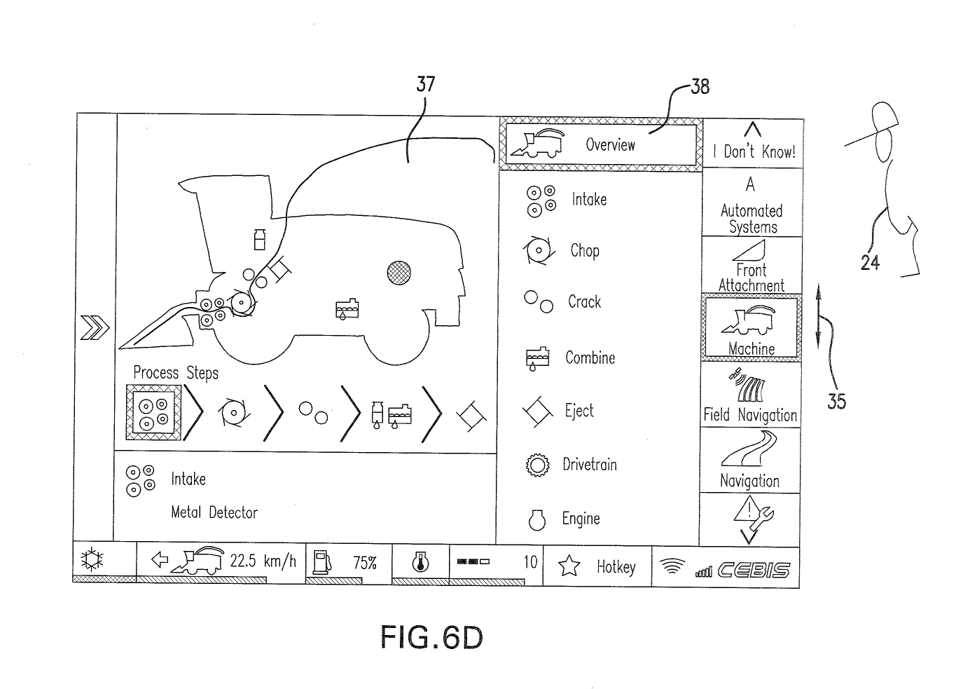

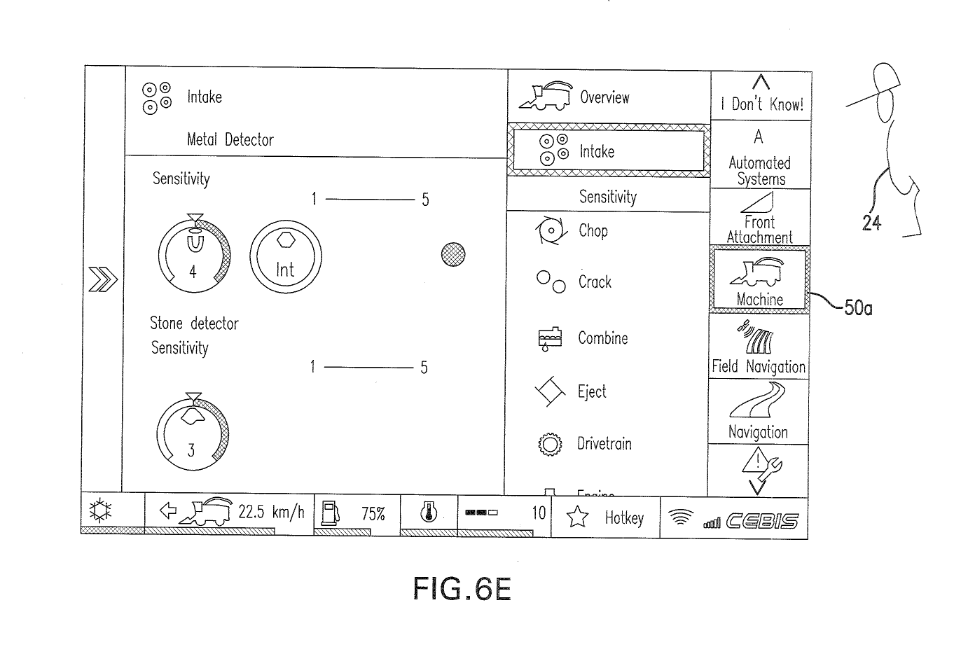

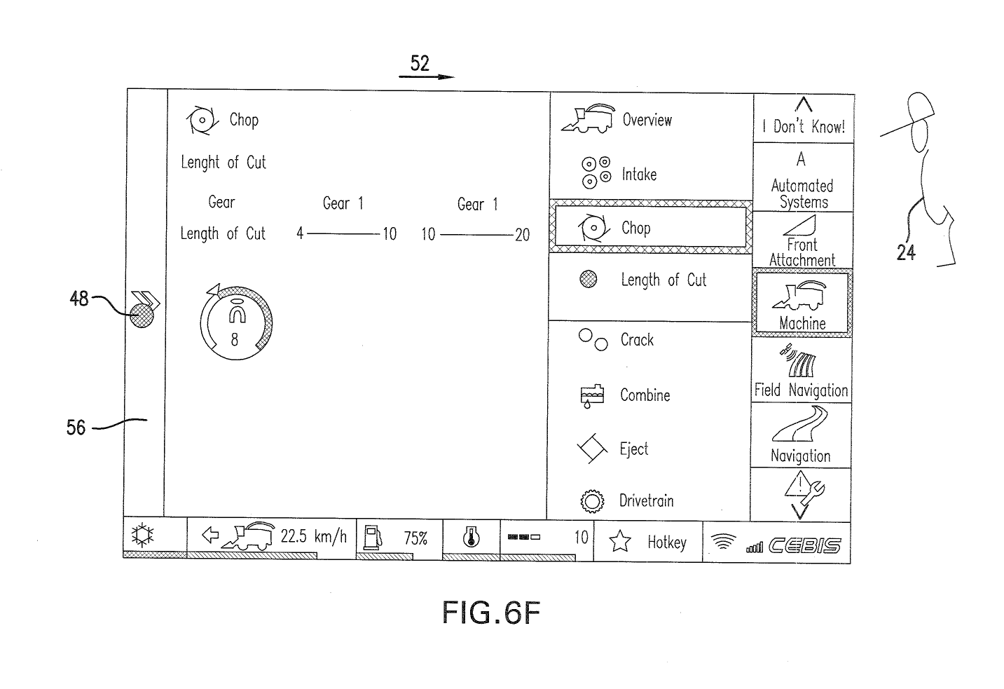

FIGS. 6A, 6B, 6C, 6D, 6E, 6F together describe navigation in the display 18 of the control and display unit 8 in the second navigation level 20. First, the operator 24 selects a tool 50 from the “tool menu” visualization region 33, which comprises all the tools 50 available on the particular agricultural working machine 1(a forage harvester 49 in this case). The “machine” tool 50a is activated by touching 48 the touchscreen monitor 21. The selection window 70 coupled to the activated tool 50a is then moved in the horizontal direction 52 into the display region of the display 18.

FIG. 6B depicts the open selection window 70 completely filling the display region of the display 18 outside of the “tool menu” visualization region 33 and outside the display region 28, which comprises the “favorites” 29 and the “hotkey” 30. According to the previous description of the structure of the display 18 in the second menu level 20, the open selection window 67 has a “tool content” visualization region 37 and a “tool submenu” visualization region 38. Navigation within each of these visualization regions 37, 38 is carried out via vertical scrolling 35. If a tool 71 stored in the “tool submenu” 38 visualization region is selected via touch 48, the selected tool 71 is emphasized along with the corresponding icon 57 in the “tool content” 37 visualization region. The emphasis is in the form of a colored background according to the depictions FIGS. 6B and 6C.

If the “tool content” visualization region 37 is then navigated by vertical scrolling 35, then vertical scrolling 35 also takes place simultaneously in the “tool submenu” visualization region, as shown in FIG. 6D. Such operation ensures that the content of the two visualization regions 37, 38 are always matched to one another and that mutually corresponding information is always visualized in the display 18. If, as shown in FIG. 6e, the parameter 64 “sensitivity of the metal detector” (for example), is selected in the “tool content” visualization region 37 once more, the “tool submenu” visualization region 38 is also automatically set. The “tool submenu” visualization region 38 is set via vertical scrolling 35 to the “metal detector/stone detector” tools 50a, which correspond to the parameter 64 “sensitivity of the metal detector”. Therefore, in this navigation variant, the visualization regions 37, 38 of the second navigation level 20 of the display 18 are coupled to one another such that editing one visualization region 37, 38 results in an automatic adaptation of the content of the corresponding visualization region 38, 37. In this navigation procedure as well, the selection window 70 is closed by touching 48 a closing bar 56 via a horizontal return motion 52.

It lies within the scope of the invention that the agricultural working machine 1, which may be controlled using the inventive control and display unit 8, is not limited to a combine harvester 2 or a forage harvester 49, but rather to have any possible agricultural working machine design known to those with skill in the art, e.g., a tractor-mounted implement combination. In addition, the parameters 64 that are set using the control and display unit 8 can be of any type, such as machine parameters, quality parameters of the agricultural working machine, quality parameters of the crop, and crop parameters.

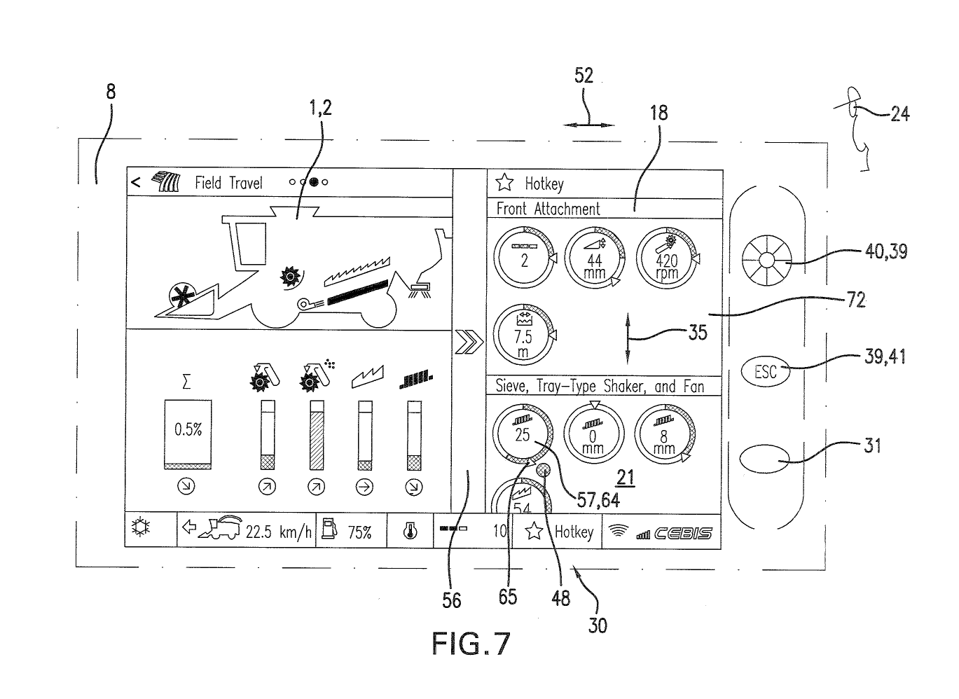

The mode of operation of the “hotkey” display region 30 is explained with reference to FIG. 7, wherein the agricultural working machine 1 is a combine harvester 2. When the operator 24 of the agricultural working machine 1 activates the “hotkey” display region 30 via touch 48, a “content” pop-up window 72 assigned to this display region opens. The “content” pop-up window moves from left to right in the horizontal direction 52 into the display region of the display 18. Vertical scrolling 35 is used to navigate within the open “content” pop-up window 72. This “content” pop-up window 72 is opened and closed by touching a closing bar 56 assigned thereto. If the control and display unit 8 according to FIG. 2 comprises a “hotkey” button 31, this button 31 also may be used to open and close the “hotkey” display region 30. The rotate-and-press switch 40 is used to navigate within the open “content” pop-up window 72. The rotate-and-press switch 40 is pressed in order to activate an icon 57 that represents a parameter 64 to be set. The selected parameter 64 is changed either in the manner described above, by dragging a marker 65 onto the display 18 (a touchscreen monitor 21) or, by rotating and pressing the rotate-and-press switch 40.

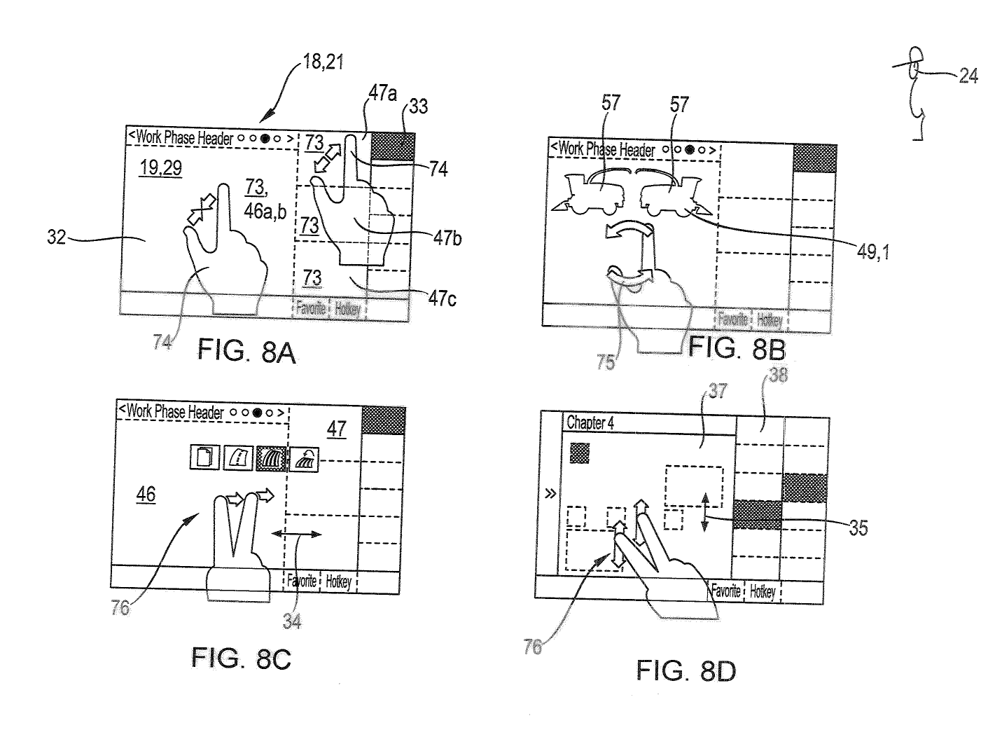

FIGS. 8A, 8B, 8C, 8D together show various actuation scenarios for a display 18 designed as a touchscreen monitor 21. As described above, the display 18 is subdivided within each navigation level 19, 20 into various visualization regions 32, 33, 37, 38, 46, 47. In order to limit the information displayed in the various visualization regions 32, 33, 37, 38, 46, 47 to essential information and/or to make the information clearly visible, the touchscreen monitor 21 is subdivided into display regions 73. Display regions 73 in the simplest case correspond to the previously described subregions 46a, b; 47a-c of the “working phase content” 46 and “tool view” 47 visualization regions. The operator 24 can zoom each of the display regions 73 via two-finger operation independently of the remaining display areas 71.

According to FIG. 8A, the particular image section can be enlarged or reduced by moving the fingers 74 toward one another or apart from each other. It is also possible, according to FIG. 8B, to create a mirror image of the visualized icon 57 via a circular motion 76 of the fingers 72 on the touchscreen monitor 21, wherein the depiction of the original icon 57 is retained. In the embodiment shown, this mirroring function causes the agricultural working machine 1 (i.e., forage harvester 55) to be shown from the right side and the left side on the display 18, making it possible to see all the details of the particular side of the machine. In a further embodiment, the touchscreen monitor 21 is designed according to the depictions of FIGS. 8C and 8D, wherein a dragging touch 76 of the display 18 in the horizontal or vertical direction can result in an increase in the speed of the vertical or horizontal scrolling 34, 35.

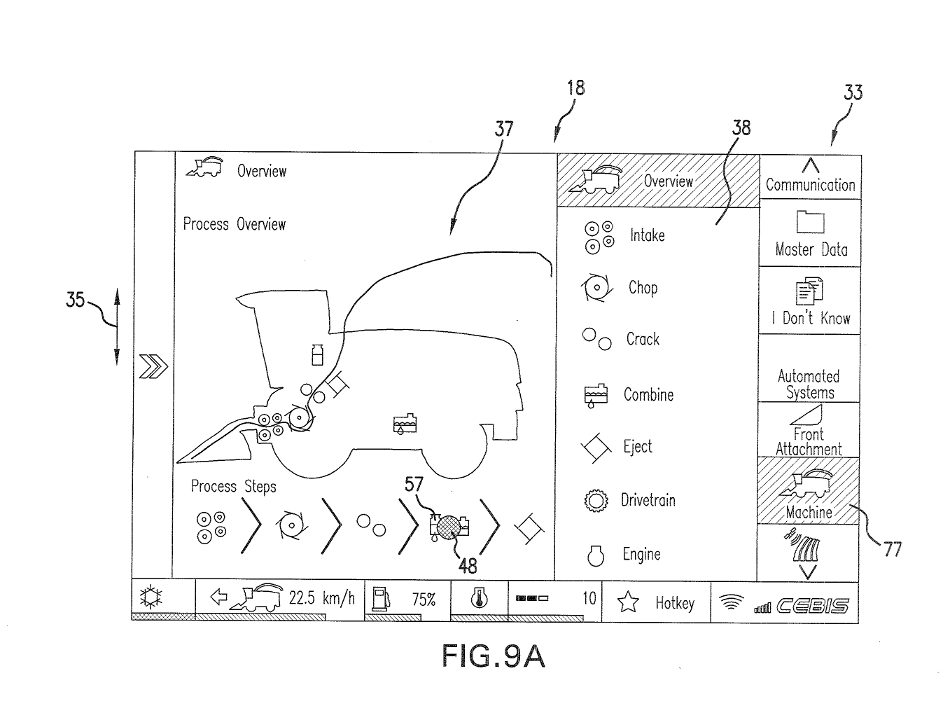

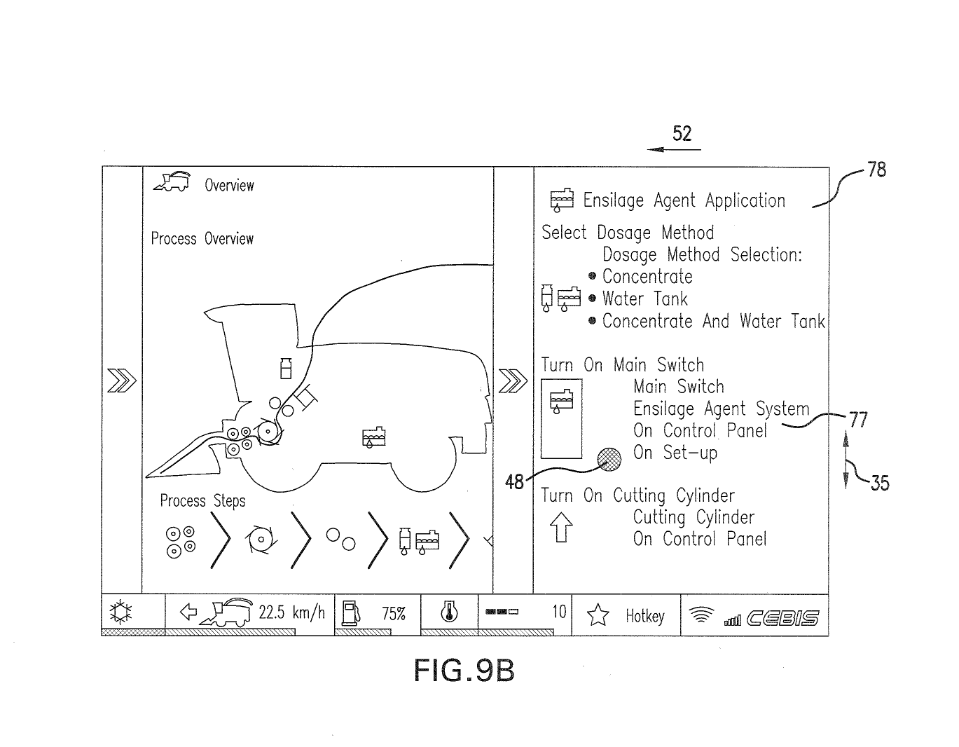

In analogy to the variant of navigation in the display 18 of the control and display unit 8 described in FIGS. 6A-F, this navigation principle is used according to FIGS. 9A and 9B to realize “control and set-up instructions” 77, which are available in the “tool menu” visualization region 33. After the “control and set-up instructions” 77 tool is activated, vertical scrolling 35 can be implemented to navigate to the icon 57 describing a certain machine function, in the “tool content” 37 and “tool submenu” 38 visualization regions, as described above. If the particular icon 57 is activated via touch 48, a “content” pop-up window 78 also is opened by being moved in the horizontal direction 52 into the display region of the display 18. Within this “content” pop-up window 78, vertical scrolling 35 can be implemented to navigate to the desired control and set-up tool 79.

### LIST OF REFERENCE CHARACTERS

1 agricultural working machine
2 combine harvester
3 working unit
4 header
5 crop
6 feed device
7 feed rake
8 control and display unit
9 first cylinder
10 second cylinder
11 separating device
12 tray-type shaker
13 cleaning unit
14 fan
15 cleaning sieve
16 swath
17 cab
18 display
19 first navigation level
20 second navigation level
21 touchscreen monitor
22 first control unit
23 second control unit
24 operator
25 header menu bar
26 display region
27 working phases
28 display region
29 “favorites” display region
30 “hotkey” display region
31 “hotkey” button
32 “working phases” visualization region
33 “tool menu” visualization region
34 horizontal scrolling
35 vertical scrolling
36 display field
37 “tool content” visualization region
38 “tool submenu” visualization region
39 control element
40 rotate-and-press switch
41 escape button
42 preparation
43 road travel
44 field travel
45 headland
46 “working phase content” visualization region
46a, b subregion
47 “tool view” visualization region
48 touch
49 forage harvester
50 tool
51 border
52 horizontal direction
53 “content” pop-up window
54, 55 editing option
56 closing bar
57 icon
58 intake conveyor mechanisms
59 chopping assembly
60 post-fragmentation device
61 post-accelerator
62 editing option
63 “content” pop-up window
64 parameter
65 marker
66 virtual sliding switch
67 plus symbol
68 minus symbol
69 virtual rotary switch
70 selection window
71 tool
72 “content” pop-up window
73 display region
74 finger
75 circular motion
76 dragging touch
77 control and set-up instructions
78 “content” pop-up window
79 control and set-up tool

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An electronic control and display unit, comprising:
at least one display (18); and
at least one control unit;
wherein the display has a plurality of visualization regions (32, 33, 37, 38, 46, 47) within and is operated in navigation levels (19, 20),
wherein the display (18) is subdivided into the visualization regions within a navigation level (19, 20), and wherein at least a portion of the visualization regions are movable relative to others of the visualization regions.

2. The electronic control and display unit according to claim 1, wherein the movability of the visualization regions (32, 33, 37, 38, 46, 47) relative to the others of the visualization regions comprises horizontal and/or vertical scrolling (34, 35) of particular visualization regions.

3. The electronic control and display unit according to claim 2, wherein the display (18) comprises, in a first navigation level (19), at least one “working phase” visualization region (32) and one “tool menu” visualization region (33) and wherein the “working phase” visualization region (32) are scrolled horizontally (34) and the “tool menu” visualization region (33) are scrolled vertically (35).

4. The electronic control and display unit according to claim 3, wherein a display field (36) becomes visible during scrolling (34) of the “working phase” visualization region (32) that displays all the selectable working phases (27; 42-45) and wherein a particular working phase that is activated (27; 42-45) is visualized in an emphasized manner.

5. The electronic control and display unit according to claim 3, wherein the “working phase” visualization region (32) comprises the working phases “preparation” (42), “road travel” (43), “field travel” (44), and “headland” (45), and wherein the visualization region (32) of each working phase (42-45) comprises a “working phase content” visualization region (48) and at least one “tool view” visualization region (47).

6. The electronic control and display unit according to claim 3, wherein at least the contents of the “working phase content” (46) and “tool view” (47) visualization regions are coupled to one another such that selecting specific content in the “working phase content” visualization region (46) results in the automatic adaptation of the content of the “tool view” visualization region (47) and, vice versa, that selecting specific content in the “tool view” visualization region (47) results in an automatic adaptation of the content of the “working phase content” visualization region (46).

7. The electronic control and display unit according to claim 2, wherein the display (18) comprises, in a second navigation level (20), at least one “tool content” visualization region (37), a “tool menu” visualization region (33), and a “tool submenu” visualization region (38), and wherein all of the visualization regions (33, 37, 38) are scrolled vertically (35).

8. The electronic control and display unit according to claim 1, wherein the display (18) is a touchscreen monitor (21) and the visualization regions (32, 33, 37, 38, 46, 47) are movable in a particular navigation level (19, 20) by touching the touchscreen monitor (21) or by activating control elements (39) assigned to the display (18) or both.

9. The electronic control and display unit according to claim 8, wherein a display region (28) visualized in all navigation levels (19, 20) is assigned to the display (18) and comprises at least one “favorites” display region (29) and a “hotkey” display region (30), and wherein system-relevant information is permanently visualized in the “favorites” display region (29) and navigation level-relevant information is visualized in the “hotkey” display region (30) by activating this display region (30).

10. The electronic control and display unit according to claim 9, wherein activation of the “hotkey” display region (30) opens a “content” pop-up window (72), which at least partially overlaps the “working phase” visualization region (32), and wherein content of the “content” pop-up window (72) is visualized and then edited by vertical scrolling (35) or actuating control elements (39).

11. The electronic control and display unit according to claim 1, wherein a header menu bar (25), which is visualized in all navigation levels (19, 20), is assigned to the display (18), and wherein activation of the header menu bar results in the immediate activation of the “working phases” visualization region (32).

12. The electronic control and display unit according to claim 1, wherein at least a portion of available visualization regions (32, 33, 37, 38, 46, 47) of each navigation level (19, 20) of the display (18) are coupled to one another such that editing one visualization region results in the automatic adaptation of the content of the corresponding visualization regions.

13. The electronic control and display unit according to claim 12, wherein touching an activated visualization region (32, 33, 37, 38, 46, 47) outside of an icon (57) that describes the visualization region causes an activated selection window (70) or pop-up window (50, 63, 78) or both to close, causes implemented changes to be reset or both.

14. The electronic control and display unit according to claim 1, wherein configuration of the display (18) is edited in at least one of the available navigation levels (19, 20).

15. The electronic control and display unit according to claim 14, wherein “working phase content” (46) and “tool view” (47) visualization regions in the first navigation level (19) comprise a plurality of configurable subregions (46a,b; 47a-c), and wherein each of the subregions (46a, b; 47a-c) can be edited such that the content of a tool (50) stored in a “tool menu” visualization region (33) can be dragged into the particular subregion (46a, b; 47a-c).

16. The electronic control and display unit according to claim 15, wherein the selected tool (50) has a plurality of editing options (54, 55), which can be selected by opening a “content” pop-up window (53), which at least partially overlaps the display (18), and selecting the editing options therein.

17. The electronic control and display unit according to claim 16, wherein the “content” pop-up window (53) is opened and closed by moving the “content” pop-up window (53) horizontally into and out of the display (18), while vertical scrolling (35) is used to navigate between selectable editing options (54, 55).

18. The electronic control and display unit according to claim 1, wherein after a working phase (27) has been activated in a “working phase” visualization region (32), a plurality of icons (57) that describe the working phase (27) is displayed, and wherein navigation within this working phase (27) and/or switching from the first navigation level (19) to the second navigation level (20) is achieved at least by activating an icon (57).

19. The electronic control and display unit according to claim 18, wherein activating an icon (57) opens a “content” pop-up window (53), which at least partially overlaps the display (18), and the content of the “content” pop-up window (53) is visualized and then edited at least by vertical scrolling (35).

20. The electronic control and display unit according to claim 19, wherein the “content” pop-up window (53), which overlaps at least partially, is visualized by being moved horizontally (52) into the visualization region of the display (18).

21. The electronic control and display unit according to claim 20, wherein the inserted “content” pop-up window (53) comprises one or more icons (57) and activating one of the icons (57) positions at least one further “content” pop-up window (63) over the previously visualized “content” pop-up window (53), and wherein the content of the “content” pop-up window (63) is visualized and then edited at least by vertical scrolling (35).

22. The electronic control and display unit according to claim 21, wherein a plurality of further “content” pop-up windows (63) can be activated subsequently, and wherein each of the subsequently activated “content” pop-up windows (63) is positioned over the previously activated “content” pop-up window (63) by being dragged horizontally (52) into the visualization region of the display (18).

23. The electronic control and display unit according claim 18, wherein an icon (57) represents a parameter (64) of a working machine (1) and activating the icon (57) results in at least one virtual rotary switch (69) being shown on the display (18), and wherein the virtual rotary switch (69) is edited in order to change the parameter (64) of the working machine (1).

24. The electronic control and display unit according to claim 23, wherein the virtual rotary switch (69) is made editable by dragging a marker (65) in a linear or circular motion, and wherein the marker (65) is activated via the touchscreen function or via control elements (39) assigned to the display (18) that include rotate-and-press switches (40).

25. The electronic control and display unit according to claim 23, wherein the working machine is an agricultural working machine (1) and the editable parameters (64) include machine parameters, quality parameters of the agricultural working machine (1), quality parameters of the crop and crop parameters.

26. The electronic control and display unit according to claim 25, wherein the “tool menu” visualization region (33) comprises all the tools (50) available on the agricultural working machine (1).

27. The electronic control and display unit according to claim 1, wherein a “tool menu” visualization region (33) comprises a “control and set-up instructions” tool (77).

28. The electronic control and display unit according to claim 1, wherein the display (18) is a touchscreen monitor (21), and wherein the touchscreen monitor (21) can be zoomed in regions.

29. The electronic control and display unit according to claim 1, wherein the display (18) is a touchscreen monitor (21) and comprises a plurality of visualized icons (57), and wherein touching the touchscreen monitor (21) with two fingers (74) making a circular motion (75) prompts a particular icon (57) to be displayed as a mirror image while an original depiction of the visualized icon (57) is retained.

30. The electronic control and display unit according to claim 1, wherein the display (18) is a touchscreen monitor (21) and scrolling (34, 35) a particular visualization region (32, 33, 37, 38, 46, 47) horizontally or vertically using two fingers (74) increases the scrolling speed.
